(19) United States
(12) Patent Application Publication
(10) Pub. No.: US 2017/0313122 A1
(43) Pub. Date: Nov. 2, 2017

(54) Pencil Sharpener

(71) Applicants: Yu-Ying Kuo, Taichung City (TW); Xiao-Hong Li, Changping (CN)

(72) Inventors: Yu-Ying Kuo, Taichung City (TW); Xiao-Hong Li, Changping (CN)

(21) Appl. No.: 15/496,012

(22) Filed: Apr. 25, 2017

(30) Foreign Application Priority Data
Apr. 29, 2016 (CN) 201620384634.6

(51) Int. Cl. B43L 23/00

(52) U.S. Cl. CPC B43L 23/008

(57) ABSTRACT

A pencil sharpener includes a main unit including a main body and a pencil sharpening device, and an outer shell detachably sleeved on the main body. The main body includes a bottom base, a supporting seat and an engaging member. The supporting seat includes a surrounding wall extending upwardly from a periphery of the bottom base, and a top wall connected to a top end of the surrounding wall. The pencil sharpening device is detachably disposed between the bottom base and the top wall. The engaging member is fixedly disposed on the surrounding wall. The outer shell includes an inner surface frictionally abutting against the engaging member. The outer shell and the surrounding wall cooperatively define a shaving collecting room.

### CROSS-REFERENCE TO RELATED APPLICATION

This application claims priority of Chinese Utility Model Patent Application No. 201620384634.6, filed on Apr. 29, 2016.

### FIELD

The disclosure relates to a pencil sharpener.

### BACKGROUND

Pencils have been widely adopted in our daily life since the invention thereof in 1795 due to low price, portability, and wide application.

After long-term use, a tip of a pencil will eventually be blunt and requires to be sharpen. The shavings generated when sharpening the pencil can be collected by a shaving collector of a pencil sharpener or a shaving collecting space defined by an outer case. However, during operation of the pencil sharpener, the shaving collector or the outer case tends to be dislodged due to vibration of the pencil sharpener.

### SUMMARY

Therefore, an object of the present disclosure is to provide a pencil sharpener that can alleviate the drawback associated with the prior art.

According to the present disclosure, a pencil sharpener includes a main unit and an outer shell.

The main unit includes a main body and a pencil sharpening device. The main body includes a bottom base, a supporting seat and at least one engaging member. The supporting seat includes a surrounding wall that extends upwardly from a periphery of the bottom base, and a top wall that is connected to a top end of the surrounding wall. The pencil sharpening device is detachably disposed between the bottom base and the top wall. The engaging member is fixedly disposed on the surrounding wall.

The outer shell is detachably sleeved on the main body and has an inner surface that frictionally abuts against the engaging member. The outer shell and the surrounding wall cooperatively define a shaving collecting room that is adapted to receive shavings during operation of the pencil sharpening device.

### BRIEF DESCRIPTION OF THE DRAWINGS

Other features and advantages of the present disclosure will become apparent in the following detailed description of the embodiment and modifications with reference to the accompanying drawings, of which:

FIG. 1 is a perspective view of an embodiment of a pencil sharpener according to the present disclosure;

FIG. 2 is a partly exploded perspective view of the embodiment;

FIG. 3 is a perspective view of a main unit of the embodiment;

FIG. 4 is a sectional view of the embodiment taken along line IV-IV of FIG. 1; and

FIG. 5 is a sectional view similar to FIG. 4, but illustrating removal of a pencil sharpening device of the embodiment.

### DETAILED DESCRIPTION

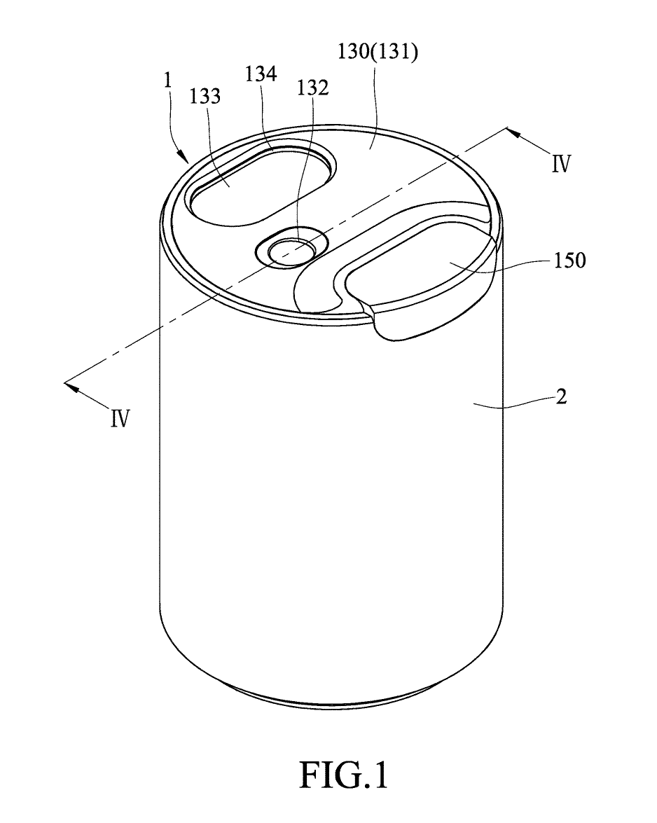

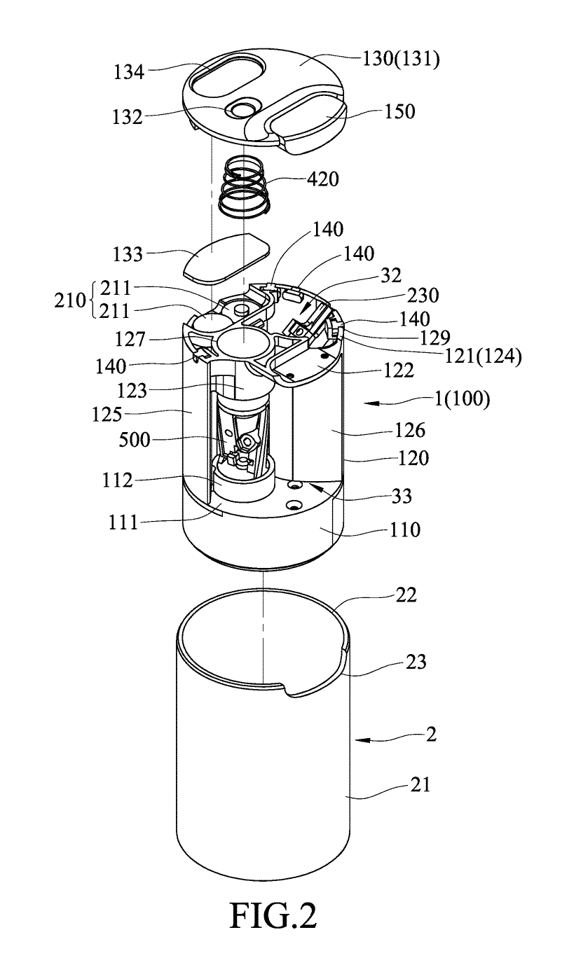

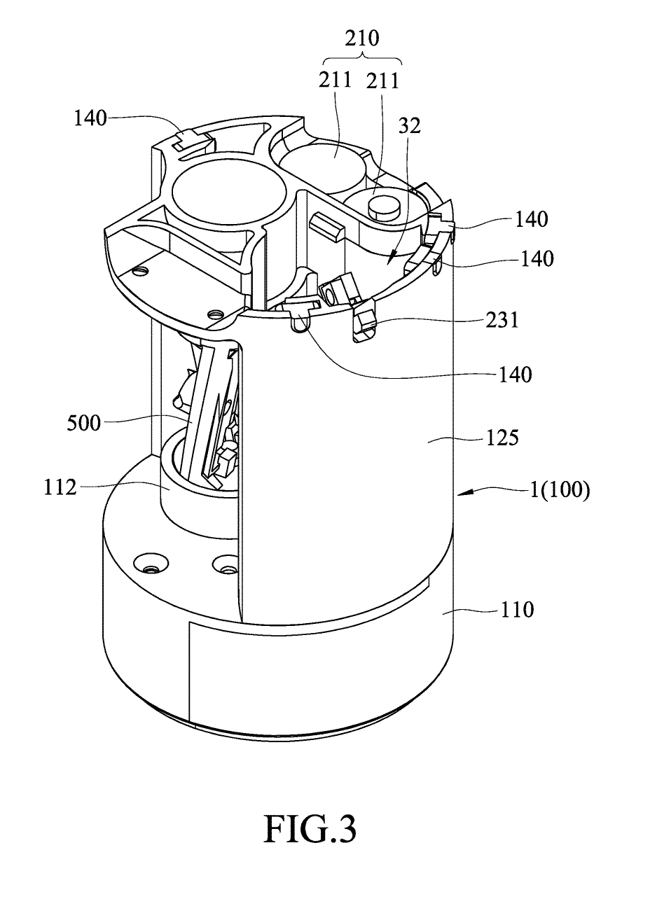

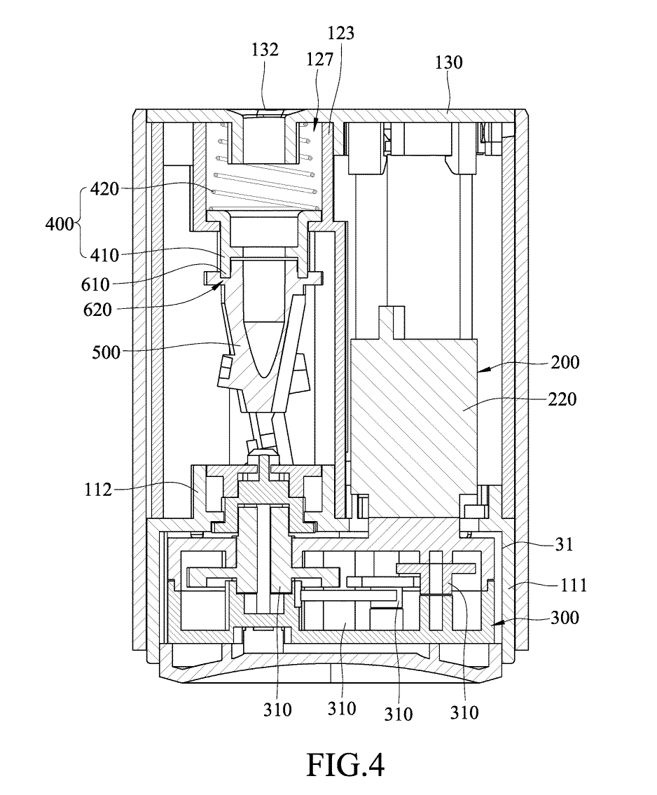

Referring to FIGS. 1 to 4, an embodiment of a pencil sharpener according to the present disclosure includes a main unit 1 and an outer shell 2.

The main unit 1 includes a main body 100, a driving device 200, a transmitting device 300, a fixing device 400 and a pencil sharpening device 500.

The outer shell 2 is detachably sleeved on the main body 100, and includes a cylindrical shell body 21 having an inner surface 22, and a notch 23 that is formed in an upper end of the shell body 21.

The main body 100 includes a bottom base 110, a supporting seat 120, a top plate 130, four engaging members 140 and a block 150 fixedly disposed on the top plate 130. The bottom base 110 includes a base body 111 that defines a transmitting room 31 therein, and a cylindrical lower holder 112 disposed on the base body 111. The supporting seat 120 includes a surrounding wall 121 that extends upwardly from a periphery of the bottom base 110, a top wall 122 that is connected to a top end of the surrounding wall 121, and a cylindrical upper holder 123 that is mounted to the top wall 122, that corresponds in position to the lower holder 112 and that has a through hole 127 penetrating the top wall 122. The surrounding wall 121 has a wall body 124 that defines a receiving space 32, and that has an outer arc surface 125 disposed along an outer peripheral portion thereof and proximate to the inner surface 22 of the outer shell 2 and an inner arc surface 126 extending from an end of the outer arc surface 125 toward the pencil sharpening device 500 for cooperating with the inner surface 22 of the outer shell 2 to define a shaving collecting room 33 that is adapted to receive shavings during operation of the pencil sharpening device 500. In other words, the outer shell 2 and the surrounding wall 121 of the supporting seat 120 of the main unit 1 cooperatively define the shaving collecting room 33. The top plate 130 is fixedly mounted to and disposed above the top wall 122. The top plate 130 includes a plate body 131, a pencil inserting hole 132 that penetrates the plate body 131 and that corresponds in position to the through hole 127 of the upper holder 123, and an electrode cover 133. The plate body 131 of the top plate 130 has a power supply exchange opening 134 that spatially communicates with the receiving space 32. The electrode cover 133 of the top plate 130 openably covers the power supply exchange opening 134. In this embodiment, the electrode cover 133 is made of a conductive metal. Compared to a conventional pencil sharpener including a plastic cover and a metal conductive sheet, the electrode cover 133 is thinner in size.

In this embodiment, the number of the engaging members 140 is four, but can be changed to less than or more than four according to practical requirements. The engaging members 140 are made of rubber, and are disposed on the wall body 124 of the surrounding wall 121 and partially protruding out of the outer arc surface 125. The outer shell 2 is prevented from easily sliding off the main body 100 through frictional contact between the inner surface 22 of the outer shell 2 and the engaging members 140.

In this embodiment, the notch 23 of the outer shell 2 corresponds in position to the block 150 such that the block 150 engages the notch 23, so as to prevent rotation of the main unit 1 in the outer shell unit 2, especially when the driving device 200 is in operation, which generates vibration to the pencil sharpener.

The driving device 200 is received in the receiving space 32, and includes a power supply 210, a motor 220 and a safety switch 230. In this embodiment, the power supply 210 includes two batteries 211 that are electrically connected in series by the electrode cover 133 and that can be replaced through the power supply exchange opening 134 when the electrode cover 133 is opened. In other words, the electrode cover 133 is electrically connected to the power supply 210. The safety switch 230 is a micro switch, and has an actuating portion 231 that protrudes out of the outer arc surface 125. When the outer shell 2 is sleeved on the main body 100, the inner surface 22 of the outer shell 2 abuts against the abutting portion 231 of the safety switch 230 so as to electrically interconnect the power supply 210 and the motor 220 such that the power supply 210 supplies an electric power to the motor 220 to drive the operation of the pencil sharpening device 500. Electrical connection between the power supply 210 and the motor 220 is interrupted through operation of the safety switch 230 when the main unit 1 is removed from the outer shell unit 2, thereby improving safety of the pencil sharpener. Alternatively, the safety switch 230 may be a proximity switch, a magnetic reed switch, etc., and can be adjusted according to practical requirements. When the safety switch 230 is the magnetic reed switch, the outer shell 2 should be provided with a magnetic member (not shown) for activating the magnetic reed switch.

The transmitting device 300 is received in the transmitting room 31 and includes a plurality of gears 310 meshed with each other and transmitting a power of the motor 220 to the pencil sharpening device 500. The fixing device 400 is mounted to the upper holder 123, and includes an assembling member 410 and a coiled compression spring 420. The assembling member 410 is disposed movably on the upper holder 123. The coiled compression spring 420 is received in the through hole 127 of the upper holder 123 and presses against the top plate 130 and the assembling member 410, such that the assembling member 410 abuts against and engages the pencil sharpening device 500 to detachably fix the pencil sharpening device 500 to the upper holder 123. That is, the pencil sharpening device 500 is detachably connected between the upper holder 123 and the lower holder 122. In certain embodiments, the assembling member 410 has one of a tongue 610 and a groove 620. The pencil sharpening device 500 has the other one of the tongue 610 and the groove 620, which engages detachably the one of the tongue 610 and the groove 620. The coiled compression spring 420 biases the tongue 610 and the groove 620 to engage each other. In this embodiment, the assembling member 410 has the tongue 610, and the pencil sharpening device 500 has the groove 620. The pencil sharpening device 500 is mounted between the assembling member 410 and the cylindrical lower holder 112. The power of the motor 220 is transmitted by the transmitting device 300 to the pencil sharpening device 500 so that the pencil sharpening device 500 is rotated with desired torque. Moreover, when the motor 220 is not operated, the pencil sharpening device 500 can be fixed between the assembling member 410 and the cylindrical lower holder 112 through tight fit between the tongue 610 and the groove 620, allowing a user to sharpen a pencil (not shown).

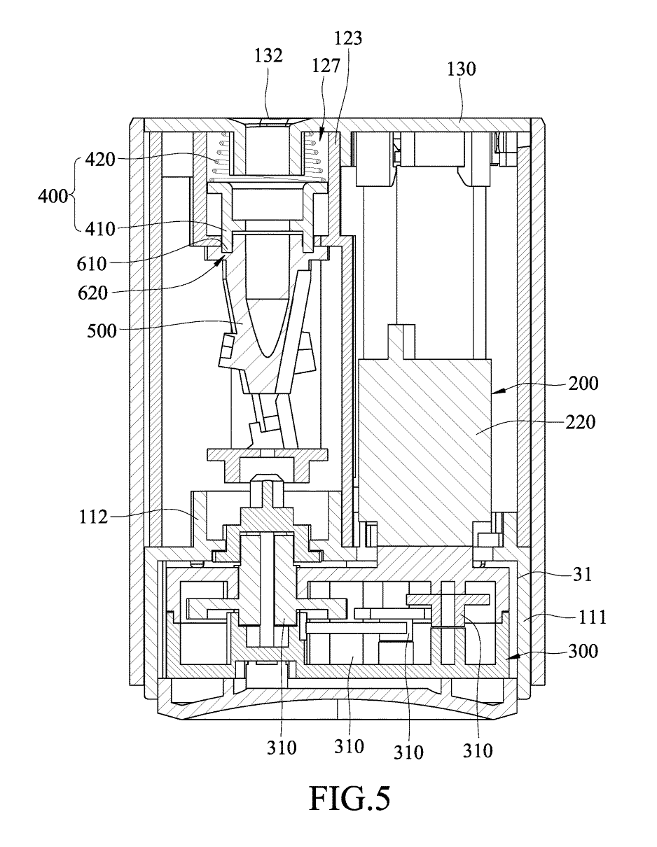

In this embodiment, the pencil sharpening device 500 can be easily replaced with the following steps. Referring to FIG. 5, when the pencil sharpening device 500 is pushed toward the top plate 13 against the biasing action of the coiled compression spring 420 to compress the coiled compression spring 420, the pencil sharpening device 500 is detached from the lower holder 112 and can be removed from the main body 100. When assembling the pencil sharpening device 500 to the main body 100, the pencil sharpening device 500 is first mounted to the assembling member 410 and pressed against the assembling member 410 to compress the coiled compression spring 420, followed by mounting the pencil sharpening device 500 to the cylindrical lower holder 112, so that the coiled compression spring 420 has a restoring force that presses the assembling member 410 against the pencil sharpening device 500 to prevent the pencil sharpening device 500 from detaching from the cylindrical lower holder 112.

In sharpening the pencil, the user can insert the pencil into the pencil inserting hole 132, allowing a tip of the pencil to press against the pencil sharpening device 500 to initiate operation of the motor 220 to drive the pencil sharpening device 500 for sharpening the pencil. The shavings generated during operation of the pencil sharpening device 500 is collected by the shaving collecting room 33 and can be easily accessed and removed after removal of the outer shell 2 from the main unit 1.

The merits of the pencil sharpener of this disclosure are summarized below.

By the frictional contact between the engaging members 140 and the inner surface 22 of the outer shell 2, the outer shell 2 is prevented from easily displaced from the main unit 1. Due to the engagement between the block 150 and the notch 23 of the outer shell 2, rotation of the main unit 1 in the outer shell unit 2 is prevented. Electrical connection between the power supply 210 and the motor 220 is interrupted through operation of the safety switch 230 when the main unit 1 is removed from the outer shell unit 2, thereby increasing safety of the pencil sharpener. The fixing device 400 facilitates the pencil sharpening device 500 to be assembled to and disassembled from the main body 100.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A pencil sharpener comprising:
a main unit including a main body and a pencil sharpening device, said main body including a bottom base, a supporting seat and at least one engaging member, said supporting seat including a surrounding wall that extends upwardly from a periphery of said bottom base, and a top wall that is connected to a top end of said surrounding wall, said pencil sharpening device being detachably disposed between said bottom base and said top wall, said engaging member being fixedly disposed on said surrounding wall; and
an outer shell being detachably sleeved on said main body and including an inner surface that frictionally abuts against said engaging member, said outer shell and said surrounding wall cooperatively defining a shaving collecting room that is adapted to receive shavings during operation of said pencil sharpening device.

2. The pencil sharpener as claimed in claim 1, wherein said main body of said main unit includes a plurality of said engaging members, said surrounding wall having a wall body that defines a receiving space and that has an outer arc surface disposed along an outer peripheral portion thereof and proximate to said inner surface of said outer shell, and an inner arc surface extending from an end of said outer arc surface toward said pencil sharpening device for cooperating with said inner surface of said outer shell to define said shaving collecting room, each of said engaging members being disposed on said wall body and partially protruding out of said outer arc surface.

3. The pencil sharpener as claimed in claim 2, wherein said main unit further includes a driving device received in said receiving space, said driving device including a power supply, a motor and a safety switch, said safety switch having an actuating portion that protrudes out of said outer arc surface, said inner surface of said outer shell abutting against said actuating portion of said safety switch so as to electrically interconnect said power supply and said motor such that said power supply supplies an electric power to said motor to drive the operation of said pencil sharpening device, electrical connection between said power supply and said motor being interrupted through operation of said safety switch when said main unit is removed from the outer shell unit.

4. The pencil sharpener as claimed in claim 3, wherein said bottom base includes a base body that defines a transmitting room, said main unit further including a transmitting device that is received in said transmitting room and that transmits a power of said motor to said pencil sharpening device.

5. The pencil sharpener as claimed in claim 1, wherein said main body further includes a top plate being fixedly mounted to and disposed above said top wall, said main body further including a block fixedly disposed on said top plate, said outer shell further including a shell body, and a notch formed in an upper end of said shell body and corresponding in position to said block such that said block engages said notch, so as to prevent rotation of said main unit in said outer shell unit.

6. The pencil sharpener as claimed in claim 3, wherein said bottom base includes a lower holder, said supporting seat further including an upper holder that is mounted to said top wall and that has a through hole penetrating said top wall, said pencil sharpening device being detachably connected between said upper holder and said lower holder.

7. The pencil sharpener as claimed in claim 6, wherein said main body further includes a top plate being fixedly mounted to and disposed above said top wall, said main unit further including a fixing device that is mounted to said upper holder and that includes an assembling member and a coiled compression spring, said assembling member being disposed movably on said upper holder, said coiled compression spring being received in said through hole of said upper holder and pressing against said top plate and said assembling member, such that said assembling member abuts against and engages said pencil sharpening device to detachably fix said pencil sharpening device to said upper holder.

8. The pencil sharpener as claimed in claim 7, wherein said assembling member has one of a tongue and a groove, said pencil sharpening device having the other one of said tongue and said groove, which engages detachably the one of said tongue and said groove, said coiled compression spring biases said tongue and said groove to engage each other.

9. The pencil sharpener as claimed in claim 6, wherein said main body further includes a top plate being fixedly mounted to and disposed above said top wall, said top plate including a plate body and a pencil inserting hole that penetrates said plate body and that corresponds in position to said through hole.

10. The pencil sharpener as claimed in claim 9, wherein said plate body of said top plate has a power supply exchange opening that spatially communicates with said receiving space and that is for replacement of said power supply therethrough, said top plate further including an electrode cover that openably covers said power supply exchange opening and that is electrically connected to said power supply.

11. The pencil sharpener as claimed in claim 10, wherein said electrode cover is made of a conductive metal, said power supply including two batteries that are electrically connected in series by said electrode cover.
